(19) United States
(12) Patent Application Publication
(10) Pub. No.: US 2026/0308792 A1
(43) Pub. Date: Oct. 8, 2026

(54) METHOD AND REACTOR FOR THE PRODUCTION OF ALKALI METAL

(71) Applicant: ELECTRIQ-GLOBAL ENERGY SOLUTIONS LTD., Tirat Carmel (IL)

(72) Inventors: Dmitry Lisitsin, Tirat Carmel (IL); Elinor Yarkony, Tirat Carmel (IL)

(21) Appl. No.: 19/481,394

(22) PCT Filed: May 2, 2024
(86) PCT No.: PCT/IL2024/050423

§ 371 Date: Nov. 4, 2025

(30) Foreign Application Priority Data
May 4, 2023 (IL) 302674

(51) Int. Cl. C25C 1/02; C25C 7/04; C25C 7/08

(52) U.S. Cl. CPC C25C 1/02; C25C 7/04; C25C 7/08

(57) ABSTRACT

The present disclosure concerns a method and reactor for producing alkali metal from a feed liquid containing alkali metal hydroxide. The method comprises feeding a feed liquid into an electrolytic cell comprising an anode region holding an anode and anolyte, a cathode region holding a cathode and catholyte comprising an alkali metal-based conductive salt in an organic solvent, and a barrier partitioning the anode region and the cathode, the barrier being selective for alkali metal cation transfer from the feed liquid, the anolyte and alkali metal based conductive salt in the catholyte share the same alkali metal cation; and applying a voltage across the electrolytic cell to cause transfer of the alkali metal cation to the cathode region and precipitation of the alkali metal on the cathode. The reactor configured for performing the method, comprises, inter alia, an electrolytic cell comprising an anode region comprising an anode, a cathode region comprising a cathode and configured for operating within an electrolyte organic solvent and a barrier partitioning the anode region from the cathode, the barrier being selective for alkali metal cation conduction.

### TECHNOLOGICAL FIELD

The present disclosure is in the field of solid alkali metal production.

### BACKGROUND ART

References considered to be relevant as background to the presently disclosed subject matter are listed below:
[1] US Patent Application Publication No US2006102491
[2] International Patent Application Publication No. WO06062673
[3] FY 2006 Annual Progress Report by Millennium Cell Inc. titled: “IV.B.1 Process for Regeneration of Sodium Borate to Sodium Borohydride for Use as a Hydrogen Storage Source” (2007) Ying Wu, Michael T. Kelly, Jeffrey V. Ortega, and Oscar A. Moreno [Process for Regeneration of Sodium Borate to Sodium Borohydride for Use as a Hydrogen Storage Source, excerpt from DOE Hydrogen Program 2006 Progress Report (energy.gov)]
[4] U.S. Pat. No. 10,538,847
[5] USA Report: “Final Report on a Survey of Electrochemical Metal Winning Processes” Battelles Memorial Institute, Department of Energy, [Office of Energy Research], Argonne National Laboratory, page 210 (1979).
US patent application publication No. 20140284219.
US patent application publication No. 202014917.

Acknowledgement of the above references herein is not to be inferred as meaning that these are in any way relevant to the patentability of the presently disclosed subject matter.

### BACKGROUND

Alkali metals, such as lithium (Li), sodium (Na) and potassium (K), are widely used in various industries, but their production is costly. Alkali metals are also highly reactive, and their production can involve a significant carbon footprint.

A common method for producing sodium metal is the Down's process, which involves the electrolysis of a molten alkali metal chloride. In this process, an electric current is passed through the molten salt, which causes the alkali metal ions to be reduced at the cathode and can then be collected as a liquid metal. The Down's process is known to be costly due to the high energy demand, the need for extreme process conditions and operational and toxicological risks. Similar challenges exist for metal Li and metal K production.

Attempts to provide alternative methods for production of alkali metals are described in the work by Millenium Cell [1-3], however, these methods lack safety stemming from potential membrane breach event. Specifically, upon membrane breach, aqueous solution from anolyte will be brought in direct contact with pure molten Na from catholyte side. This will initiate immediate exothermic reaction of molten Na with water producing heat and hydrogen in high amounts with consecutive fire and explosion effect being catastrophic for large scale systems. Since the occasional membrane leak/breach is unavoidable in large scale systems running continuously for a long time, Millenium Cell methods are unsuitable for industrial scale.

U.S. Pat. No. 10,538,847 [4] describes another process using an electrochemical cell having organic solution of Sodium sulfide (Na₂S) in the anode compartment, and molten Na in catholyte compartment. In this process elemental sulfur is precipitated on the anode and no oxygen is released from the anode region.

Other electrochemical cells for producing alkali metal from a feed of liquid containing sodium hydroxide are described in US20140284219 and US202014917.

### GENERAL DESCRIPTION

The presently disclosed subject matter is based on the development of a method and reactor that allows production of alkali metal from alkali hydroxide in an aqueous solution (anolyte solution), and at temperatures that are significantly lower than the temperatures used in Down's process, without production of hazardous gaseous Cl₂, and at a significantly lower overall cost.

Specifically, as exemplified herein, the presently disclosed subject matter allows for alkali metal production at temperatures that are below 150° C.

Further, the catholyte contains organic solution which would inherently prevent reaction of anolyte with metal Na upon membrane breach. Low voltages and current densities utilized in the presently disclosed subject matter are thus also cost effective from the large scale, energy consumption perspective.

Thus, in accordance with a first aspect of the presently disclosed subject matter there is provided a method of producing alkali metal from a feed liquid containing alkali metal hydroxide, the method comprising:
feeding the feed liquid into an electrolytic cell comprising an anode region holding an anode and an anolyte, a cathode region holding a cathode and a catholyte containing an alkali metal-based conductive salt in an electrolyte organic solvent, and a barrier partitioning the anode region and the cathode, the barrier being selective for alkali metal cation transfer from said feed liquid, said anolyte and alkali metal based conductive salt in said catholyte share the same alkali metal cation; and
applying a voltage across the electrolytic cell to cause transfer of alkali metal cation to said cathode region and precipitation of the alkali metal on the cathode.

In accordance with a second aspect of the presently disclosed subject matter there is provided a reactor for use with a source of alkali metal hydroxide in an aqueous media, the reactor comprising:
an electrolytic cell comprising an anode region comprising an anode, a cathode region comprising a cathode configured for operating within an electrolyte organic solvent and a barrier partitioning the anode region from the cathode region, the barrier being selective for alkali metal cation conduction;
a power source configured for applying a voltage across the electrolytic cell;
a feed inlet in liquid communication with said source of alkali metal hydroxide;
an alkali metal outlet configured for discharging alkali metal from said cathode region; and
at least one gas outlet configured for discharge of gas from said anode region to the atmosphere.

In accordance with a third aspect of the presently disclosed subject matter there is provided a plant comprising a spent fuel treatment unit and a reactor for use according to the presently disclosed subject-matter
wherein the spent fuel treatment unit is configured to receive the spent fuel and produce from the spent fuel XBH₄ where X represents an alkali metal cation; and
wherein the spent fuel treatment is configured to receive from the reactor precipitated Na, wherein Na can be the same or different from X, and to discharge a stream of the NaOH waste into the reactor.

For example, a plant for potassium borohydride production comprising a spent fuel treatment unit comprising sodium hydroxide waste which is recovered as metal Na.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic illustration of a reactor for use with a source of alkali metal hydroxide in accordance with some examples of the presently disclosed subject matter.

FIG. 2 is a schematic illustrations of an alternative reactor design in accordance with some other examples of the presently disclosed subject matter, showing the configuration of a cation selective membrane type barrier within the electrolytic cell, where the anode and the cathode are within a same chamber.

FIG. 3 is a schematic illustration of an alternative reactor design in accordance with some other examples of the presently disclosed subject matter, showing the configuration of a cation selective membrane type barrier within the electrolytic cell, where the anode and the cathode are in two separate chambers.

FIG. 4 is a schematic illustration of yet another alternative reactor design in accordance with some other examples of the presently disclosed subject matter, showing the configuration of a cation selective membrane type barrier within the electrolytic cell, where the reactor comprises two, separately operated, cathode chambers.

FIG. 5 is a schematic illustration of a further alternative reactor design in accordance with yet some other examples of the presently disclosed subject matter, showing the configuration of a gel polymer electrolyte type barrier within the electrolytic cell.

FIG. 6 is a schematic illustration of a further alternative reactor design in accordance with yet another configuration of a gel polymer electrolyte type barrier within the electrolytic cell according to the presently disclosed subject matter.

FIGS. 7A-7E are images showing overnight exposure of Na pieces to Glyme (FIG. 7A), Diglyme (FIG. 7B), NMP (FIG. 7C), Dibutyl Glyme (FIG. 7D) and THF (FIG. 7E).

FIGS. 8A-8B are images showing the effect of one day (FIG. 8A) and one week (FIG. 8B) exposure of the Na pieces to diglyme.

FIGS. 9A-9B are images of an electrolytic cell for use according to some examples of the presently disclosed subject matter (FIG. 8A) and its set up as part of a reactor according to some examples of the presently disclosed subject matter (FIG. 8B)

### DETAILED DESCRIPTION

The presently disclosed subject matter is based on the development of a method for production of solid alkali metal, a reactor configured for performing the herein disclosed method and a plant including the reactor. The disclosed method, reactor and plant are particularly suitable for production of any one of solid sodium, solid potassium and solid lithium.

Generally, the method disclosed herein involves electro-precipitation in an electrolytic cell that comprises an alkali metal cation selective barrier.

The presently disclosed technology was developed with an aim to achieve a low energy solid alkali metal, such as solid Na production process operated at exceptionally high level of process safety and simplicity, that would render it suitable for large scale production. The presently disclosed subject matter allows for the alkali metal to be generated in solid form even at room temperature, thereby reducing its reactivity to a minimum.

In addition, the catholyte and alkali metal-based conductive salt in the cathode region are selected, in accordance with the presently disclosed subject matter, to avoid reaction of the alkali metal with aqueous alkali hydroxide (XOH) solution upon membrane breach event.

Specifically, the method according to a first aspect of the presently disclosed subject matter is for producing alkali metal from a feed liquid, the method comprises:
feeding the feed liquid containing alkali metal hydroxide into an electrolytic cell comprising an anode region holding an anode and an anolyte, a cathode region holding a cathode and a catholyte containing alkali metal-based conductive salt in an organic solvent, and a barrier partitioning said anode region and said cathode, said barrier being selective for alkali metal cation transfer, the feed liquid, anolyte and alkali metal based conductive salt in said catholyte share a common alkali metal cation; and
applying a voltage across the electrolytic cell to cause transfer of alkali metal cation to said cathode region and precipitation of said alkali metal on said cathode.

The reactor disclosed here, that is for use with a source of alkali metal hydroxide in an aqueous media and is configured and operable, a priori, for producing solid alkali metal, comprises:
an electrolytic cell comprising an anode region comprising an anode, a cathode region comprising a cathode configured for operating within an electrolyte organic solvent and a barrier partitioning the anode region from the cathode, the barrier being selective for alkali metal cation conduction;
a power source configured for applying a voltage across the electrolytic cell;
a feed inlet in liquid communication with said source of alkali metal hydroxide;
an alkali metal outlet configured for discharging alkali metal from said cathode region; and

at least one gas outlet configured for discharge of gas from said anode region to the atmosphere.

The plant disclosed herein, that includes the presently disclosed reactor, further comprises spent fuel treatment unit, the spent fuel treatment unit is configured to receive the spent fuel and produce from said spent fuel XBH₄, the X represent an alkali metal cation; and the spent fuel treatment is configured to receive precipitated alkali metal Y from the reactor and to discharge a stream of said XOH waste into the reactor.

It has been found that the presently disclosed subject matter is particularly suitable for alkali metal production using the anolyte XOH solution (the source of the alkali metal) that is readily available as a waste stream of “other chemical process” that also consume in the overall process alkali metal. In this way the presently disclosed subject matter allows for a closed cycle loop where the expensive and energy consuming alkali metal is internally generated from recycled waste in a green and low energy process.

In some examples of the presently disclosed subject matter, the plant uses waste NaOH. Currently, in the known Brown-Schlesinger process used globally for NaBH₄ or KBH₄ production, on industrial scale, 4 moles of metal Na are consumed for generation of one mole of either NaBH₄ or KBH₄ and 3 moles of NaOH waste are generated in case of NaBH₄ and 4 moles of waste NaOH are generated in case of KBH₄. The generated NaOH can then be processed back to solid Na according to the presently disclosed subject matter.

The presently disclosed subject matter becomes of particular interest in a newly developed green hydrogen release process from KBH₄. In this specific, yet not-limiting process hydrogen in a catalytically controlled process by mixing the solid KBH₄ with water according to the following simplified reaction:

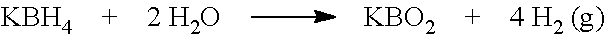

The hydrogen release process waste is an aqueous KBO₂ solution called spent fuel. This spent fuel can be recovered back to KBH₄ by applying Brown Schlesinger process while the metal Na required for this route will be sourced out of generated NaOH waste.

In the above and below description, whenever referring to the presently disclosed subject matter, it is to be understood to refer and define, independently, the presently disclosed method, the presently disclosed reactor and the presently disclosed plant.

For the purpose of producing solid alkali metal, the feed liquid in the presently disclosed subject matter comprises at least alkali hydroxide.

In some examples of the presently disclosed subject matter, the alkali hydroxide is at least sodium hydroxide (NaOH).

In some examples of the presently disclosed subject matter, the alkali hydroxide is at least potassium hydroxide (KOH).

In some examples of the presently disclosed subject matter, the alkali hydroxide is at least lithium hydroxide (LiOH).

In accordance with the presently disclosed subject matter, the feed liquid can be any liquid comprising a high concentration of the alkali hydroxide.

In some preferred examples, the feed liquid is an aqueous liquid/solution.

When referring to “high concentration” of the sodium hydroxide or potassium hydroxide it is to be understood to encompass a liquid comprising at least 35 wt % of the sodium or potassium hydroxide. In some examples, the liquid comprises at least 36 wt % sodium or potassium hydroxide; at times, at least 37 wt %; at times, at least 38 wt %; at times, at least 39 wt %; at times, at least 40 wt %; at times, at least 41 wt %; at times, at least 42 wt %; at times, at least 43 wt %; at times, at least 44 wt %; at times, at least 45 wt %; at times, at least 46 wt %; at times, at least 47 wt %; at times, at least 48 wt %; at times, at least 49 wt %; at times, at least 50 wt %; at times, at least 51 wt %; at times, at least 52 wt %; at times, at least 53 wt %; at times, at least 54 wt %; at times, at least 55 wt %.

When referring to “high concentration” of lithium hydroxide it is to be understood to encompass a liquid comprising at least 12 wt % of the lithium hydroxide. In some examples, the liquid comprises at least 14 wt %; at times, at least 16 wt %; at times, at least 18 wt %; at times, at least 20 wt %; at times, at least 22 wt %; at times, at least 24 wt %; at times, at least 26 wt %; at times, at least 28 wt %; at times, at least 30 wt %.

In some examples of the presently disclosed subject matter, the “high concentration” for the alkali hydroxide solution is up to the saturation concentration of the respective alkali metal hydroxide.

In some examples of the presently disclosed subject matter, the feed liquid is an aqueous solution comprising a high concentration of at least one alkali hydroxide. In some examples, at least one alkali hydroxide is at least sodium hydroxide.

In some examples of the presently disclosed subject matter, the feed liquid comprises, in addition to the at least one alkali hydroxide some organic residues and/or divalent and/or monovalent ions, typically to an extend of up to several thousand ppms, each.

In accordance with presently disclosed subject matter, the feed liquid is fed into an electrolytic cell. The electrolytic cell comprises an anode region comprising at least one anode and liquid that is referred to, at times, as the anolyte, a cathode region comprising at least one cathode and liquid that is referred to as, at times, as the catholyte, and a barrier that divides the anode region and the cathode region, the barrier being selective for alkali metal cation transfer.

In accordance with some examples of the presently disclosed subject matter, when referring to a region holding at least one cathode and a region holding at least one anode, it is to be understood to refer to two distinct physical areas/zones with the electrolytic cell that are separated one from the other by at least the alkali metal selective barrier.

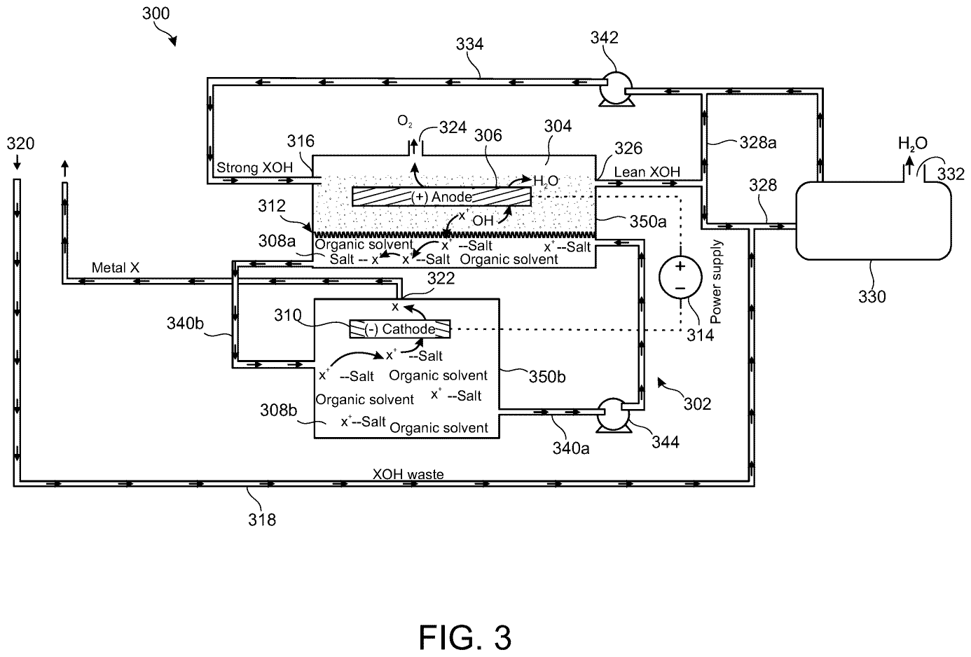

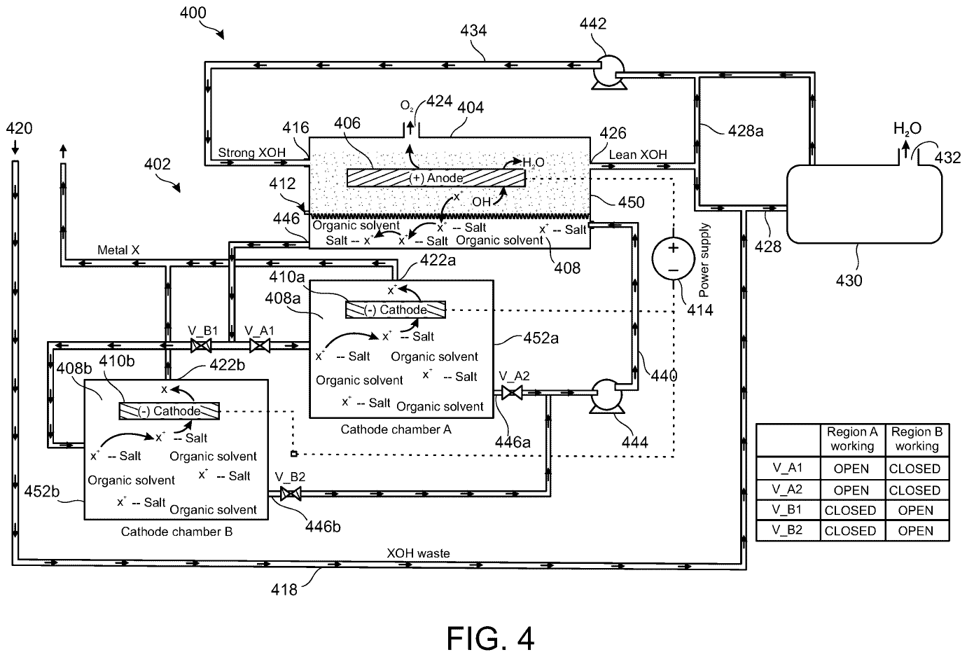

In some examples of the presently disclosed subject matter, such as the configuration illustrated in FIG. 3 or 4 (further discussed below), the anode is located in a first housing/chamber while the cathode is located in another, second housing/chamber. The first chamber is divided into an anode region and a cathode region by the alkali metal cation selective barrier, with no fluid communication therebetween). Yet, there is fluid communication between the cathode region of the first chamber and the cathode region in the second chamber.

In some examples of the presently disclosed subject matter, as illustrated in the Exemplary FIG. 3, the cell comprises two chambers, a first chamber holding the barrier, partitioning between the anode region and the anode, and a cathode region, the latter being in liquid communication with an additional chamber, referred to as the cathode chamber, holding the cathode.

In accordance with some examples of the presently disclosed subject matter, the reactor comprises two or more separately operated cathode chambers, the two or more cathode chambers housing, respectively, two or more cathode regions, each cathode region containing a cathode, as illustrated in FIG. 4.

Further, in accordance with some examples of the presently disclosed subject matter, particularly when including two or more cathode chambers, the reactor comprises at least one valve (switchable from an open state to a closed state) for separately opening and closing flow of catholyte into each of the two or more cathode chambers. Optionally, when including two or more cathode chambers, the method and reactor can be operated to introduce catholyte into at least one of said two or more chambers while optionally ceasing operation of at least one other of said two or more cathode chambers.

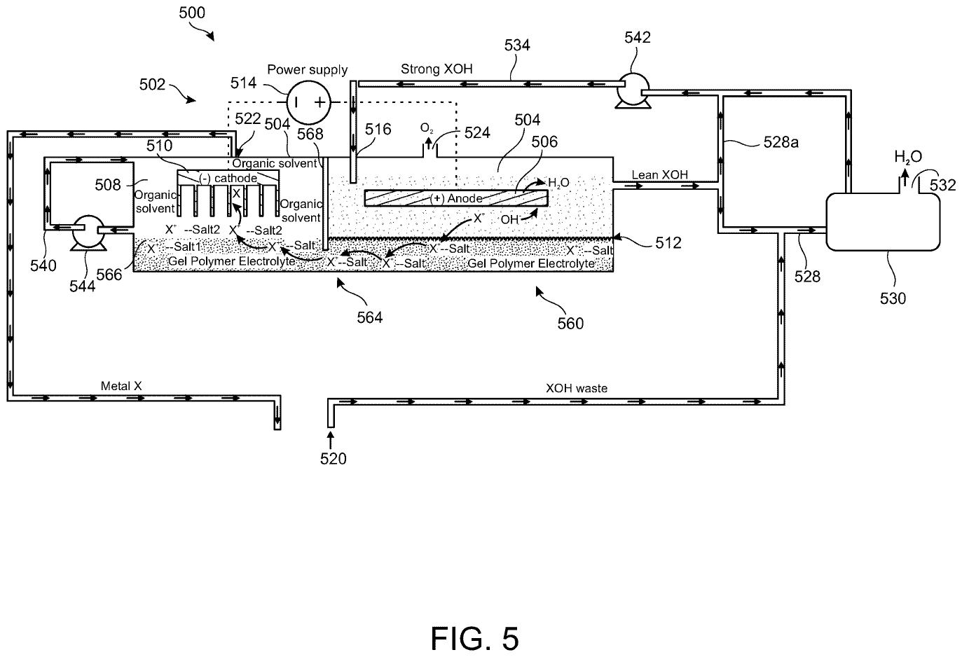

In some other examples of the presently disclosed subject matter, such as the configuration illustrated in Exemplary FIG. 5 (further discussed below), the anode and cathode are located within a same housing and are the cathode region and anode region are also separated by a physical partition (in addition to the partitioning of the alkali metal selective barrier).

In accordance with the presently disclosed subject matter, the cathode, in the cathode region, is embedded in a non-aqueous catholyte containing alkali metal based salt.

In the context of the presently disclosed subject matter, the term “non-aqueous catholyte” is to be understood to refer to any water-free liquid medium. In the context of the present disclosure, the term “water-free” should be understood to encompass liquid with no or only up to several tens of ppm of water.

The catholyte within the cathode region comprises at least one organic solvent and at least one alkali metal-based conductive salt. In the context of the presently disclosed subject matter, the alkali metal-based conductive salt comprises an alkali metal cation that is selected to be identical to the alkali metal cation in hydroxide solution feeding the anode region. In other words, the anolyte, the feed liquid and the alkali metal based conductive salt in the catholyte have the same alkali metal. For example, in case the feed liquid comprises NaOH, the anolyte and the catholyte also comprise Na⁺.

In some examples of the presently disclosed subject matter, the at least one electrolyte organic solvent including the alkali metal-based conductive salt is characterized by a viscosity of less than 10 cP.

In some examples of the presently disclosed subject matter, the at least one electrolyte organic solvent is characterized having stability towards solid alkali metal, namely, does not react with the solid alkali metal.

In some examples of the presently disclosed subject matter, the at least one electrolyte organic solvent is characterized by a wide electrochemical window, i.e. the reduction potential of the electrolyte organic solvent is sufficiently high to prevent competitive reaction on the cathode. In some examples of the presently disclosed subject matter, the reduction potential of the electrolyte organic solvent is higher than that of the alkali metal cation. For example, when the presently disclosed subject matter is utilized for providing solid sodium, the electrolyte organic solvent has reduction potential of at least 3V (about 0.3V higher than that of Na⁺).

In some examples of the presently disclosed subject matter, the at least one electrolyte organic solvent is selected from the group consisting of 1,3-Dioxolan-2-one (EC, also known as Ethylene carbonate), dimethyl carbonate (DMC), N,N-diethyl-4-methylpiperazine-1-carboxamide (DEC, also known as diethyl carbonate), 4-methyl-1,3-dioxolan-2-one (PC), methylethyl carbonate (MEC) 4-Fluoro-1,3-dioxolan-2-one (FEC, also known as fluoroethylene carbonate), Oxolane (THF), N,N-Dimethylacetamid (DMAC), N,N-dimethylformamide (DMF), 1-Methylpyrrolidin-2-one (NMP), thiolane 1,1-dioxide (Sulfolane), 1,2-Dimethoxyethane (DME), 1-Methoxy-2-(2-methoxyethoxy) ethane (Diglyme), 2,5,8,11-Tetraoxadodecane (Triglyme), 2,5,8,11,14-Pentaoxapentadecane (Tetraglyme), 1-propoxypropane (DPE), Diethylene glycol dibenzoate (DEGD), Poly(ethylene glycol) (PEG), PEG-dimethyl ether (PEGDEM), Poly(propylene glycol) (PPG), and Tris(2-ethylhexyl)phosphate (TEHP), 1,1,3,3-Tetramethylurea (TMU), 1,1,3,3-Tetraethylurea (TEU), and 1,3-Dimethyl-1,3-diazinan-2-one (DMPU) or alike

In some examples of the presently disclosed subject matter, specifically when the alkali metal hydroxide is sodium hydroxide (and the solid metal thus formed is solid sodium), the electrolyte organic solvent is selected from the group consisting of 1,3-Dioxolan-2-one (EC), dimethyl carbonate (DMC), diethyl carbonate (DEC), 4-methyl-1,3-dioxolan-2-one (PC), dimethyl carbonate (DMC), methylethyl carbonate (MEC) fluoroethylene carbonate (FEC), Oxolane (THF), N,N-Dimethylacetamid (DMAC), N,N-dimethylformamide (DMF), 1-Methylpyrrolidin-2-one (NMP), thiolane 1,1-dioxide (Sulfolane), 1,2-Dimethoxyethane (DME), 1-Methoxy-2-(2-methoxyethoxy) ethane (Diglyme), 2,5,8,11-Tetraoxadodecane (Triglyme), 2,5,8,11,14-Pentaoxapentadecane (Tetraglyme), 1-propoxypropane (DPE), 1,1,3,3-Tetramethylurea (TMU), 1,1,3,3-Tetraethylurea (TEU), and 1,3-Dimethyl-1,3-diazinan-2-one (DMPU).

In some examples of the presently disclosed subject matter the at least one electrolyte organic solvent is diglyme and/or sulfolane and/or NMP.

In some examples of the presently disclosed subject matter, the alkali metal-based conductive salt in the non-aqueous catholyte is characterized by a solubility in the respective electrolyte organic solvent of at least 0.5M; at times of more than 0.5M, e.g. 0.6M; 0.7M, 0.8M, 1M, 1.2M depending on the type of salt and the selected electrolyte organic solvent.

In some examples of the presently disclosed subject matter, the alkali metal-based conductive salt in the non-aqueous catholyte is characterized by a conductivity (in the electrolyte organic solvent) of at least 2 mS/cm, when determined at room temperature.

In some examples of the presently disclosed subject matter, the alkali metal-based conductive salt in the non-aqueous catholyte is one that has no interaction with the electrolyte organic solvent in which it is dissolved.

In some examples of the presently disclosed subject matter, the alkali metal-based conductive salt in the non-aqueous catholyte is characterized by a wide electrochemical window, i.e. its reduction potential is sufficiently high to prevent its competitive reaction on the cathode.

In some examples of the presently disclosed subject matter, the alkali metal-based conductive salt in the non-aqueous catholyte comprises at least one anion selected from the group consisting of perchlorate (ClO₄⁻), hexafluorophosphate (PF₆⁻), tetrafluoroborate (BF₄⁻), bis(trifluoromethanesulfonyl)imide (N(CF₃SO₂)₂⁻, TFSI), triflate (NaCF₃SO₃⁻, Tf), bis(fluorosulfonyl)imide (N(FSO₂)₂⁻, FSI), F⁻, I⁻, bis(oxalate)borate (BOB), bis(salicylato)borate (BSB), and tetraphenylborate (BPh₄⁻) or alike.

In some examples of the presently disclosed subject matter, when the feed liquid comprises sodium hydroxide (as the alkali metal hydroxide), the alkali metal based conductive salt is a sodium-based conductive salt.

In some examples of the presently disclosed subject matter, when the feed liquid comprises sodium hydroxide, the alkali metal based conductive salt is NaClO₄.

In some examples of the presently disclosed subject matter, when the feed liquid comprises sodium hydroxide, the alkali metal based conductive salt is NaPF₆.

In some examples of the presently disclosed subject matter, when the feed liquid comprises sodium hydroxide, the alkali metal based conductive salt is NaBF₄.

In some examples of the presently disclosed subject matter, when the feed liquid comprises sodium hydroxide, the alkali metal based conductive salt is NaTFSI.

In some examples of the presently disclosed subject matter, when the feed liquid comprises lithium hydroxide (as the alkali metal hydroxide), the alkali metal based conductive salt is a lithium-based conductive salt.

In some examples of the presently disclosed subject matter, when the feed liquid comprises potassium hydroxide (as the alkali metal hydroxide), the alkali metal based conductive salt is a potassium based conductive salt.

As noted above, the cathode region and the anode region are partitioned and the cation selective barrier forms at least part of the partitioning element between the two regions.

Cation selective barriers used in an electrolytic cell are known in the art.

In accordance with the presently disclosed subject matter, the cation selective membrane is one having high conductivity at room temperature.

In some examples of the presently disclosed subject matter, the cation selective membrane has a conductivity of at least 1×10⁻⁴ S/cm (0.1 mS/cm); at times, at least about 0.2 mS/cm; at times, at least about 0.3 mS/cm; at times, at least about 0.4 mS/cm; at times, at least about 0.5 mS/cm.

In some examples of the presently disclosed subject matter, the alkali metal selective barrier comprises a solid electrolyte. In some examples, the solid electrolyte is a ceramic cation selective membrane.

A non-limiting list of ceramic cation selective membranes that can be used in accordance with the presently disclosed subject matter include, sodium superionic conductor (NaSICON) potassium superionic conductor (KSICON), lithium superionic conductor (LiSICON) and/or β-Alumina.

SICON is a family of ceramic materials having a crystal structure, typically composed of sodium, phosphorus, oxygen, and other elements, and is known to exhibit high ionic conductivity for alkali ions, e.g. sodium ions (Na⁺).

Thus, in accordance with a specific example of the presently disclosed subject matter, when utilized for the production of sodium, the alkali metal selective barrier can be preferably NaSICON.

Thus, in accordance with a specific example of the presently disclosed subject matter, when utilized for the production of potassium, the alkali metal selective barrier can be preferably KSICON.

Thus, in accordance with a specific example of the presently disclosed subject matter, when utilized for the production of lithium, the alkali metal selective barrier can be preferably LiSICON.

In some examples of the presently disclosed subject matter, the alkali metal selective barrier comprises perfluorosulfonic acid polymer (sulfonated tetrafluoroethylene based fluoropolymer-copolymer, also known by the IUPAC name ethanesulfonyl fluoride, 2-[1-[difluoro-[(trifluoroethenyl)oxy]methyl]-1,2,2,2-tetrafluoroethoxy]-1,1,2,2,-tetrafluoro-, with tetrafluoroethylene (CAS number 66796-30-3)), known by the tradename Nafion® membranes.

In some examples, when Nafion type membrane is selected, it may be modified to reduce water passage while keeping sufficient cation permeability to allow effective transfer of the cation to the cathode region.

In some examples of the presently disclosed subject matter, the alkali metal selective barrier comprises a gel polymer electrolyte (GPE). A gel polymer electrolyte is typically composed of a solid polymer(s)/polymer matrix impregnated with liquid electrolytes, resulting in a gel like consistency.

In some examples of the presently disclosed subject matter, the GPE comprises at least one polymer selected from the group consisting of polyethylene oxide (PEO, poly(oxyethylene), Poly-vinylidene fluoride (PVDF, poly-1,1-difluoroethene), Polyvinylidene fluoride-hexafluoropropylene (PVDF-HFP, poly-1,1-difluoroethene co 1,1,2,3,3,3-Hexafluoroprop-1-ene), Polyacrylonitrile (PAN), Poly(methyl methacrylate) (PMMA, Poly(methyl 2-methylpropenoate)) or alike.

In some examples of the presently disclosed subject matter, the GPE comprises at least PVDF-HFP.

In some examples of the presently disclosed subject matter, the GPE comprises at least one organic plasticizer such as those commonly used in GPE systems of electrolytic cells.

A non-limiting list of examples of plasticizers that can be used in a GPE in accordance with the presently disclosed subject matter includes 1,3-Dioxolan-2-one (EC, also known as Ethylene carbonate), dimethyl carbonate (DMC), N,N-diethyl-4-methylpiperazine-1-carboxamide (DEC, also known as diethyl carbonate), 4-methyl-1,3-dioxolan-2-one (PC), methylethyl carbonate (MEC) 4-Fluoro-1,3-dioxolan-2-one (FEC, also known as fluoroethylene carbonate), Oxolane (THF), N,N-Dimethylacetamid (DMAC), N,N-dimethylformamide (DMF), 1-Methylpyrrolidin-2-one (NMP), thiolane 1,1-dioxide (Sulfolane), 1,2-Dimethoxyethane (DME), 1-Methoxy-2-(2-methoxyethoxy) ethane (Diglyme), 2,5,8,11-Tetraoxadodecane (Triglyme), 2,5,8,11,14-Pentaoxapentadecane (Tetraglyme), 1-propoxypropane (DPE), Diethylene glycol dibenzoate (DEGD), Poly(ethylene glycol) (PEG), PEG-dimethyl ether (PEGDEM), Poly(propylene glycol) (PPG), and Tris(2-ethylhexyl)phosphate (TEHP), 1,1,3,3-Tetramethylurea (TMU), 1,1,3,3-Tetraethylurea (TEU), and 1,3-Dimethyl-1,3-diazinan-2-one (DMPU) and any combination of same.

In some examples of the presently disclosed subject matter, particularly when said alkali metal to be formed is solid sodium, the plasticizer is selected from the group consisting of 1,3-Dioxolan-2-one (EC), dimethyl carbonate (DMC), diethyl carbonate (DEC), 4-methyl-1,3-dioxolan-2-one (PC), dimethyl carbonate (DMC), methylethyl carbonate (MEC) fluoroethylene carbonate (FEC), Oxolane (THF), N,N-Dimethylacetamid (DMAC), N,N-dimethylformamide (DMF), 1-Methylpyrrolidin-2-one (NMP), thiolane 1,1-dioxide (Sulfolane), 1,2-Dimethoxyethane (DME), 1-Methoxy-2-(2-methoxyethoxy) ethane (Diglyme), 2,5,8,11-Tetraoxadodecane (Triglyme), 2,5,8,11,14-Pentaoxapentadecane (Tetraglyme), 1-propoxypropane (DPE), 1,1,3,3-Tetramethylurea (TMU), 1,1,3,3-Tetraethylurea (TEU), and 1,3-Dimethyl-1,3-diazinan-2-one (DMPU) and any combination of same.

In some examples of the presently disclosed subject matter, the plasticizer in the GPE comprises EC, PC or a combination of same.

In some examples of the presently disclosed subject matter, the plasticizer in the GPE comprises a combination of EC and PC.

In some examples of the presently disclosed subject matter, the plasticizer(s) within the GPE is/are identical to the electrolyte organic solvent in the non-aqueous catholyte.

In some examples of the presently disclosed subject matter, there is some overlap between the plasticizer(s) within the GPE and the electrolyte organic solvent in the non-aqueous catholyte (e.g. they commonly share at least one organic molecule).

In some examples of the presently disclosed subject matter, the plasticizer within the GPE is different from the electrolyte organic solvent in the non-aqueous catholyte (i.e. have no common compounds).

The GPE comprises at least one alkali metal-based conductive salt. The at least one alkali metal-based conductive salt has the same meaning as defined above with respect to the non-aqueous catholyte. Yet, it is to be appreciated that the alkali metal-based conductive salt forming part of the catholyte is not necessarily the same as that forming part of the GPE.

The counter ion to any of the above anions utilized as part of the catholyte and/or part of the GPE can be sodium or lithium. Thus, for example, when the anion is perchlorate, it is to be understood that the salt employed can be NaClO₄, KClO₄ or LiClO₄.

Other salts that can be used include, according to the non-limiting list provided hereinabove, sodium perchlorate (NaClO₄), sodium hexafluorophosphate (NaPF₆), sodium tetrafluoroborate (NaBF₄), sodium bis(trifluoromethanesulfonyl)imide (NaN(CF₃SO₂)₂, NaTFSI), sodium triflate (NaCF₃SO₃, NaTf), sodium bis(fluorosulfonyl)imide (NaN(FSO₂)₂, NaFSI), NaI, sodium bis(oxalate)borate (NaBOB), sodium bis(salicylato)borate (NaBSB), sodium tetraphenylborate (NaBPh₄), lithium hexafluorophosphate (LiPF₆), Lithium bis(trifluoromethanesulfonyl)imide (LiTFSI), Lithium tetrafluoroborate (LiBF₄), Lithium perchlorate (LiClO₄) and Lithium bis(fluorosulfonyl)imide (LiN(CF₃SO₂)₂); KClO₄, KPF₆, KBF₄.

In some examples of the presently disclosed subject matter, the alkali metal-based conductive salt is a sodium salt.

In some examples, when the presently disclosed subject matter is for the production of solid sodium, the alkali metal-based conductive salt in the catholyte and/or in the GPE is selected from the group consisting of NaClO₄, NaPF₆, NaBF₄, NaN(CF₃SO₂)₂, NaCF₃SO₃, NaN(FSO₂)₂, NaI, NaBOB, NaBSB, NaBPh₄ or alike

In some examples of the presently disclosed subject matter, when utilized for the production of solid lithium, the alkali metal-based conductive salt used in the catholyte and/or in the GPE is a lithium salt.

In some examples, when the presently disclosed subject matter is for the production of solid lithium, the alkali metal-based conductive salt is selected from the group consisting of LiPF₆, LiTFSI, LiBF₄, LiClO₄ and LiN(CF₃SO₂)₂ or alike

In some examples of the presently disclosed subject matter, when utilized for the production of solid potassium, the alkali metal-based conductive salt in the catholyte and/or in the GPE is a potassium salt.

In some examples, when the presently disclosed subject matter is for the production of solid potassium, the in the catholyte and/or in the GPE is selected from the group consisting of KClO₄, KPF₆, KBF₄.

In some examples of the presently disclosed subject matter, when the solid alkali metal being produced is solid sodium, the GPE comprises a combination of Poly-vinylidene fluoride-hexafluoropropylene (PVDF-HFP), 1,3-Dioxolan-2-one (EC), 4-methyl-1,3-dioxolan-2-one (PC), and PF₆⁻.

In some examples of the presently disclosed subject matter the GPE are characterized by high conductivity of at least 1 mS/cm, at room temperature.

Further, in some examples of the presently disclosed subject matter the GPE are characterized by wide electrochemical window preventing redox reactions of the polymer and good stability towards metal Na.

As explained above with respect to the electrolyte organic solvent, a wide electrochemical window preventing redox reaction is to be understood to mean that the reduction potential of the GPE as a whole is sufficiently high to prevent competitive reaction on the cathode. In some examples of the presently disclosed subject matter, the reduction potential of the GPE is higher than that of the alkali metal cation. For example, when the presently disclosed subject matter is utilized for providing solid sodium, the GPE as a whole has reduction potential of at least 3V (about 0.3V higher than that of Na⁺).

Further, when referring to good stability towards alkali metal it is to be understood to mean that the GPE does not react with the solid alkali metal.

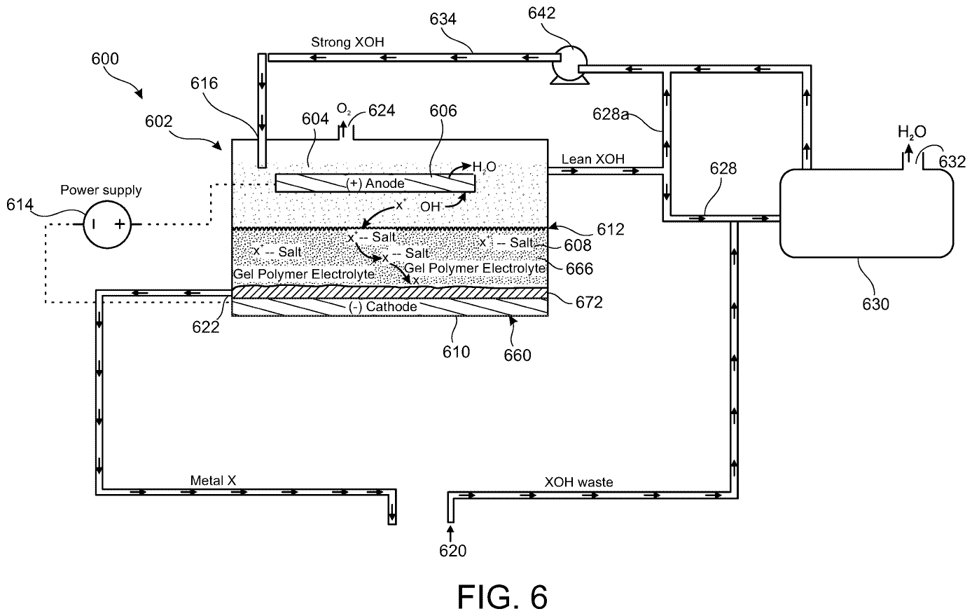

In some examples of the presently disclosed subject matter, the barrier can comprise a combination of an alkali metal cation selective membrane and GPE, as schematically illustrated in the non-limiting FIG. 5 or FIG. 6. Without being limited thereto, the combination of GPE and a cation selective membrane, as defined herein may ensure a complete separation of the anode region and the anolyte from the cathode region and the catholyte, and thus reduce the risk of breach between the two regions.

The presently disclosed subject matter requires that the feed liquid comprises high concentrations of hydroxide, as defined herein above. To this end, and in accordance with some examples of the presently disclosed subject matter, the concentration of the hydroxide anions in the feed liquid is controlled to be above a predetermined threshold. In the context of the presently disclosed subject matter, the “predetermined threshold” is the concentration below which the solid alkali metal formed by the disclosed method and reactor reacts with water, if the solid alkali metal and the water accidently come into contact (e.g. breach of the selective membrane).

In some examples of the presently disclosed subject matter, the “predetermined threshold” is a concentration which is 2%-5% above the concentration limit below which the reaction with water occurs. Fluctuations in the predetermined threshold may depend on reaction parameters such as temperature, accuracy of measurement and/or safety equipment.

The predetermined threshold would be specific to each alkali metal to be formed.

In some examples of the presently disclosed subject matter, the alkali metal formed is solid sodium and the predetermined threshold is 40%.

In some examples of the presently disclosed subject matter, the alkali metal formed is solid sodium and the predetermined threshold is 35%.

In some examples of the presently disclosed subject matter, the alkali metal formed is solid lithium and the predetermined threshold is determined based on LiOH solubility under the reaction conditions (e.g. temperature).

In some examples of the presently disclosed subject matter, the alkali metal formed is solid potassium and the predetermined threshold is determined based on KOH solubility under the reaction conditions (e.g. temperature).

In some examples of the presently disclosed subject matter, the feed liquid is liquid waste comprising high concentrations of alkali hydroxide.

In the context of the presently disclosed subject matter, the term “liquid waste” should be understood to encompass any water-based liquid comprising at least alkali hydroxide.

In some examples of the presently disclosed subject matter, the liquid waste originates from the process of de-alkalization of spent fuel.

In some examples of the presently disclosed subject matter, the liquid waste originates from KBH₄ generation process, and the liquid waste would then contain sodium hydroxide (NaOH) as generally described hereinabove.

In some other examples, liquid waste can be obtained from other sources such as spent NaOH cleaning solution in the food and chemicals industry.

In some examples of the presently disclosed subject matter, the concentration of the alkali hydroxide in the feed liquid is below the predetermined threshold suitable for performing the disclosed method and/or for operating the disclosed reactor. In such cases, the presently disclosed subject matter provides for alkali metal makeup, namely, increase in the concentration of the alkali metal in the feed liquid.

The presently disclosed subject matter comprises applying voltage across the cathode region and the anode region, to thereby cause the alkali cation to migrate from the anode region towards the cathode region, through the cation selective barrier. As appreciated by those versed in the art, at the cathode, the alkali cations gain electrons and thereby are reduced to their elemental form, depositing on the surface of the cathode.

In the anode region, the remaining hydroxides are oxidized to form gaseous oxygen (O₂) and water (H₂O).

Thus, generally, the presently disclosed subject matter allows for the following reactions to take place:

### Anode Region:

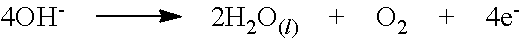

### Cathode Region:

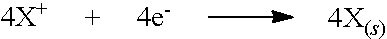

### Overall:

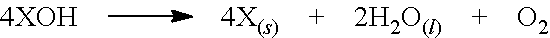

Specifically, when the alkali hydroxide is sodium hydroxide, the following reactions take place:

### Anode:

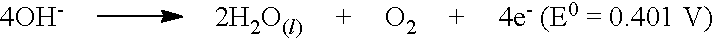

### Cathode:

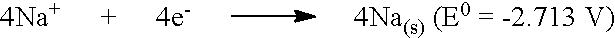

### Overall:

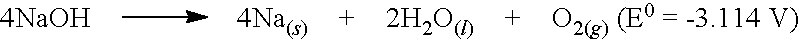

The reaction taking place in the anode region leads to reduction in alkali hydroxide concentration. Liquid within the anode region that is low in alkali hydroxide concentration, namely, the concentration being below the predetermined threshold, and is referred to at times, by the term “lean alkali hydroxide solution”.

In some examples of the presently disclosed subject matter, at least a portion, preferably all of the anolyte solution from the anode region that may be considered “lean alkali hydroxide solution” is processed, the processing comprises (i) water evaporation from the liquid (the “lean alkali hydroxide solution”) to thereby increase concentration of alkali hydroxide (at times referred to by the term “concentrated alkali hydroxide solution”), and (ii) recirculating the alkali metal hydroxide enriched liquid into said anode region.

For illustration only of the purpose of the anolyte processing, assuming a predefined threshold concentration of alkali hydroxide in the anode is 35%, transfer of alkali metal cation to the cathode region through the alkali metal cation selective barrier may result in reduction of concentration below the threshold due to OH ions oxidation to water. This reduction is compensated by evaporation of generated water using the evaporator, where water from anolyte solution is removed, thereby increasing the concentration of anolyte recycled back to the anode region to ~36-37%.

Without being bound by theory, it is to be appreciated that the concentration of alkali hydroxide in the anode region should be controlled to be high (above the predefined threshold) in order to avoid reaction of solid alkali metal with water, in case there is a breach in the barrier.

In some examples of the presently disclosed subject matter, the oxygen produced in the anode region is released to the atmosphere (e.g. via a dedicated outlet, as further described below). In some examples of the presently disclosed subject matter, the release of oxygen is an essentially continuous release of the oxygen.

In the cathode region, the solid alkali metal either precipitates on the cathode or, e.g. in cases where the cathode has a smooth surface, the solid alkali metal may remain floating in the catholyte. Thus, to avoid recirculating of solid alkali metal into the anolyte, the presently disclosed subject matter also comprises a catholyte recycling (settling) tank operable to separate between solid alkali metal and recirculate catholyte into the cathode region.

The presently disclosed subject matter is characterized by low operating temperatures, being below 300° C.

In some examples of the presently disclosed subject matter, the operation temperature is below about 250° C.; at times, below about 200° C.; at times, below about 150° C.; at times, below about 120° C.; at times, below about 100° C.; at times, below about 90° C.; at times, below about 80° C.; at times, below about 70° C.; at times, below about 60° C.; at times, below about 50° C.

In some examples of the presently disclosed subject matter, the operation temperature is between about 15° C. and 290° C.; at times, between about 15° C. and 250° C.; at times, between about 15° C. and about 200° C.; at times, between about 15° C. and about 150° C.; at times, between about 15° C. and about 120° C.; at times, between about 15° C. and about 100° C.; at times, between about 15° C. and about 80° C.; at times, between about 15° C. and about 70° C.; at times, between about 15° C. and about 60° C.; at times, between about 15° C. and about 50° C.; at times, between about 15° C. and about 40° C.; at times, between about 15° C. and about 35° C.

In some examples of the presently disclosed subject matter, when the alkali metal is sodium, the temperature is typically below 120° C.; at times, between about 15° C. and about 60° C.; at times, between about 15° C. and about 50° C.; at times, between about 15° C. and about 40° C.; at times, between about 15° C. and about 35° C.

In some preferred examples, the operation temperature is selected to produce solid alkali metal at the cathode region. In such cases, the operational temperature is selected based on the solid alkali metal to be produced. In some examples of the presently disclosed subject matter, the temperature or temperature range are below the melting temperature of the alkali metal to be produced.

In some examples of the presently disclosed subject matter, the temperature can be above the melting temperature of the alkali metal. Yet, in such cases additional measures need to be executed in the cathode region to allow its operation in the presence of molten alkali metal. In addition, measures need to be taken to allow the cell to operate under elevated temperatures to avoid boiling of the anolyte in the anode region.

The presently disclosed subject matter is characterized by a total cell potential (TCP) of below 5V; at times, below 4.9V; at times, below 4.8V; at times, below 4.7V; at times, below 4.6V; at times, below 4.5V; at times, below 4.4V; at times, below 4.3V; at times, below 4.2V; at times, below 4.1V; at times, below 4.0V; at times, below 3.9V; at times, below 3.8V; at times, below 3.7V; at times, below 3.6V; at times, below 3.5V; at times, below 3.4V; at times, below 3.3V; at times, below 3.2V.

The presently disclosed subject matter is characterized by an open cell potential (OCP) of about 3.114 in case of Na metal production, 3.335 in case of Li metal production and 3.444 in case of K metal production.

When said alkali metal is sodium, the presently disclosed subject matter is characterized by a total energy consumption that is less than 5 kWh per kg alkali metal produced.

When said alkali metal is potassium or lithium, the presently disclosed subject matter is characterized by a total energy consumption that is less than 6 kWh per kg alkali metal produced.

The presently disclosed subject matter is characterized by a current density of less than about 200 mA/cm². In some examples of the presently disclosed subject matter, said current density is between about 50 mA/cm² and about 200 mA/cm²; at times, between about 50 mA/cm² and about 150 mA/cm²; at times, between about 50 mA/cm² and about 100 mA/cm².

The presently disclosed subject matter is characterized by a current efficiency of >99%, as determined by dividing the following equation:

$$\% = \frac{Current resulted from alkali metal production}{Total Applied current} \times 100$$

The presently disclosed subject matter exhibited unique process features, particularly when compared to the commonly known Down's process. Briefly, Down's process converts molten NaCl to molten Na and a hazardous gaseous Cl₂ by electrochemical process under conditions of very high current density and high temperatures of typically 600° C.-800° C.

Table 1 provides a brief comparison between several parameters of the presently disclosed subject matter (“Current Method”) and that of the Down's process, based on experimental data obtained in the production of solid Na. Similar significant differences are to be expected in the production of solid potassium or solid lithium.

TABLE 1
Process Operating Parameters

| | | Current |
|---|---|---|
| Parameter | Down's Process | Method |
| Temperature | >300° C., preferably 600° | <50° C. |
| | C.-800° C. | |
| Metal Na | Hot molten Na | Cold solid Na |
| Corrosive gases | Cl₂ | No |
| OCP* (V) | 4.07 | 3.11 |
| Over Voltage | 3 | 0.9 |
| Current Efficiency | <80% | >99% |
| Total EC | typically >12.0 KWh/Kg_{Na} | <5 KWh/Kg_{Na} |
| Current Density | 10,000 A/m² | 500-1,000 |
| | | A/m² |

*OCP—Open Cell Potential

The resulting solid alkali metal is deposited and/or precipitated on the cathode at the cathode region. The precipitated metal is removed from the cathode region.

In some examples of the presently disclosed subject matter, solid alkali metal is periodically removed from the cathode region. Removal is typically done during cessation of operation of the electrolytic cell within the reactor.

In some examples of the presently disclosed subject matter, solid alkali metal that is deposited on the surface of the cathode (e.g. when using a rough or foam type cathode) is removed from the cathode by introducing the cathode into a hot oil bath (being at a temperature above the melting temperature of the solid metal). The solid metal would then melt and be collected as a liquid molten from the bottom of the hot oil bath. In some examples of the presently disclosed subject matter, e.g. when the metal is solid sodium, the hot oil bath can be set at a temperature above 97° C. (melting temperature of metal Na).

In some other examples of the presently disclosed subject matter, solid alkali metal that is suspended in the catholyte, e.g. when the cathode has an extremely smooth surface, onto which the solid alkali metal cannot be strongly attached. The suspended solid metal would then be suspended in the catholyte recycling solution and can then be collected outside the electrolytic cell by using a dedicated settling unit/tank to which catholyte stream is communicated.

As noted above, the presently disclosed subject matter includes also a reactor for use with a source of alkali metal hydroxide in an aqueous medium.

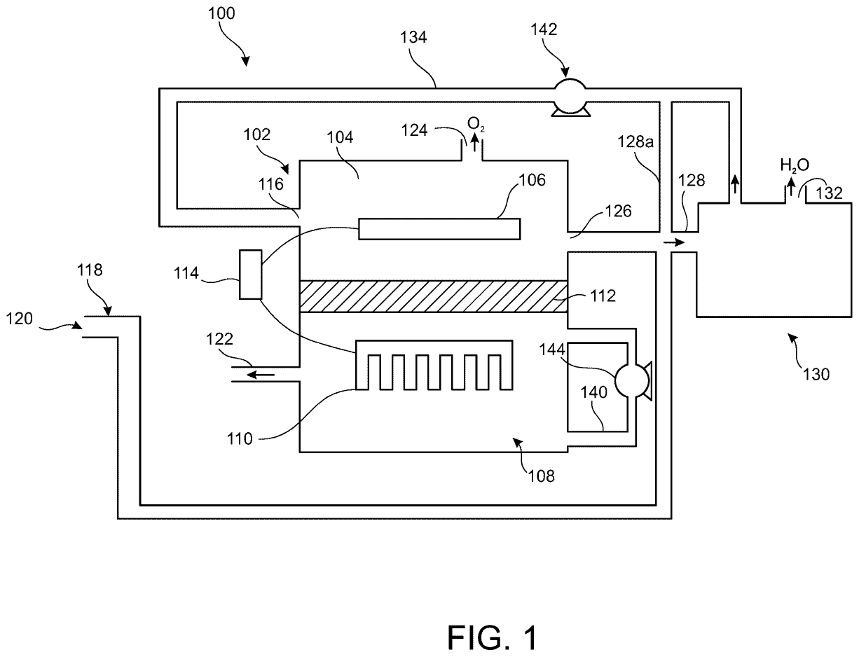

Reference is made to FIG. 1 providing a schematic illustration of basic components of a reactor for converting alkali metal hydroxide (XOH waste) to alkali metal (Metal X) according to some examples of the presently disclosed subject matter.

Specifically, FIG. 1 provides a reactor 100 comprising an electrolytic cell 102, the electrolytic cell 102 comprises an anode region 104, comprising an anode 106 configured for operating within an aqueous media within the anode region 104. The electrolytic cell 102 also comprises a cathode region 108 comprising a cathode 110 configured for operating within a non-aqueous media; and a barrier 112 partitioning the anode region 104 from the cathode region 108 or at least from the cathode 110. Barrier 112 is a barrier selective for alkali metal cation conduction.

Electrolytic cell 102 also comprises power source 114, configured for applying a voltage across the electrolytic cell 102, so as to cause the transfer and precipitation of alkali metal on cathode 110.

electrolytic cell 102 also comprises in anode region 104 at least one gas outlet 124 configured for discharging gas (specifically oxygen and preferably, continuously discharging) from the anode region 104 e.g. to the atmosphere.

Cathode region 108 is configured to circulate non-aqueous catholyte therewithin via circulating streamline 140, operated by the aid of pump 144.

In addition to electrolytic cell 102, reactor 100 also comprises streamline 118, connecting a source of alkali metal hydroxide 120 to an evaporating unit 130. Evaporating unit 130 received aqueous based liquid (referred to at times as XOH waste) from a source of alkali metal hydroxide 120 and from anode region 104, via streamline 128 and is configured to evaporate water via outlet 132. The feed line from source 120 and anolyte from anode region 104 are preferably mixed prior to being introduced into evaporating unit 130. By evaporating water, alkali metal hydroxide enriched liquid is obtained in evaporating unit 130 which in turn is fed through streamline 134 and feed inlet 116, into anode region 104, optionally by the aid of a pump such as pump 142.

In operation, XOH waste communicated as streamline 118 is firstly mixed with lean XOH, exiting anode region from anode outlet 126 and the mixture is fed into evaporating unit 130, where it is treated to obtain a XOH rich liquid. The XOH rich liquid is circulated into anode region via streamline 134 and feed inlet 116, optionally by the aid of a pump such as pump 142. Alkali metal cation is transferred from the anode region 104 into the cathode region 108, via the alkali metal cation selective membrane, where the alkali metal is produced and communicated out of electrolytic cell 102 via outlet 122.

In some examples, at least part of the anolyte solution exiting the anode region via outlet 126 can bypass the evaporating unit 130 and be recirculated into the anode region, by the aid pump 142 via streamline 128a. The extent of this bypass stream can be dictated by the type and efficiency of the evaporating unit 130 or and by the concentration of raw XOH waste presented in stream 118.

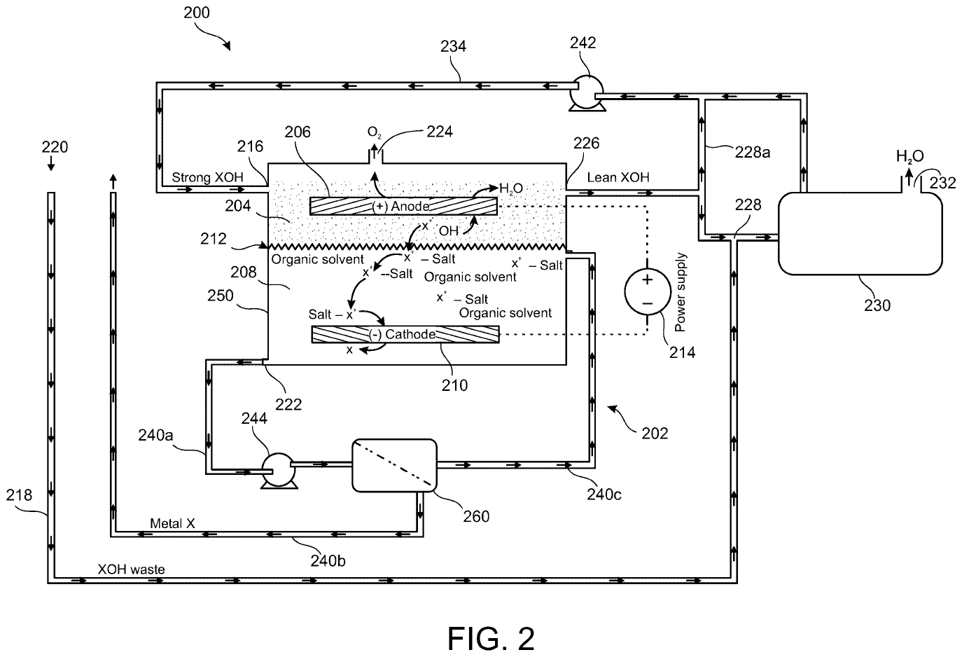

Reactor 100 also comprises an alkali metal outlet 122 configured for removing alkali metal from cathode region 108. Alkali metal outlet 122 can be connected to an alkali metal filtration/settling unit as illustrated in FIG. 2.

In some examples of the presently disclosed subject matter, and while not specifically illustrated in FIG. 1, the reactor can comprise at least one control unit for controlling at least one operation parameter of said reactor.

Reference is now made to FIG. 2, which schematically illustrates another reactor in accordance with the presently disclosed subject matter. For simplicity, like reference numerals to those used in FIG. 1, shifted by 100 are used to identify components having a similar function in FIG. 2. For example, component 206 in FIG. 2 is an anode having the same function as anode 106 in FIG. 1.

Specifically, FIG. 2 provides a reactor 200 for converting alkali metal hydroxide (XOH waste) to alkali metal (Metal X). Reactor 200 comprises an electrolytic cell 202, comprising a chamber 250 that is divided into an anode region 204, comprising an anode 206 and configured to operate in an aqueous environment, a cathode region 208 holding cathode 210 and configured to operate in a non-aqueous environment; and a barrier 212 partitioning the anode region 204 from the cathode region 208. Barrier 212 in this non-limiting example is a solid cation selective membrane as described and defined hereinabove.

Electrolytic cell 202 also comprises a power source 214 connected to anode 206 and cathode 210, configured for applying a voltage across the electrolytic cell 202, so as to cause the transfer and precipitation of alkali metal on cathode 210.

Electrolytic cell 202 comprises in anode region 204 at least one gas outlet 224 configured for discharging gas (specifically oxygen and preferably, continuously discharging) from the anode region 204 e.g. to the atmosphere.

In addition to electrolytic cell 202, reactor 200 also comprises streamline 218, connecting a source of alkali metal hydroxide 220 to an evaporating unit 230. Evaporating unit 230 received aqueous based liquid from the source of alkali metal hydroxide 220 and from anode region 204 and is configured to evaporate water from the received liquid, via outlet 232. The feed line from source 220 and anolyte from anode region 204 are preferably mixed prior to being introduced into evaporating unit 230. By evaporating water, evaporating unit 230 provides liquid enriched with alkali metal hydroxide that is then fed through streamline 234 and feed inlet 216, into anode region 204, optionally by the aid of a pump such as pump 242.

In some examples, at least part of the anolyte solution exiting the anode region via outlet 226 can bypass the evaporating unit 230 and be recirculated into anode region 204 by the aid pump 242 via streamline 228a. The extent of this bypass stream is dictated by the type and efficiency of the evaporating unit 230 and/or and by the concentration of raw XOH waste presented in stream 218.

In operation, feed liquid comprising XOH flowing in streamline 218 is mixed with XOH from anode region 204, and the mixture in streamline 228 is fed into evaporating unit 230 to reach a desired XOH concentration before entering the anode region via inlet 204. The XOH rich liquid is circulated into anode region via streamline 234 and feed inlet 216, optionally by the aid of a pump such as pump 242.

Alkali metal cations are transferred from anode region 204 into cathode region 208, via the alkali metal cation selective membrane, where the alkali metal is produced and communicated out of electrolytic cell 202 via outlet 222.

Reactor 200 also comprises an alkali metal filtration/settling unit 260 configured, by the aid of pump 244, to receive non-aqueous catholyte via streamline 240a, to isolate any suspended solid alkali metal from the catholyte, and recirculate liquid XOH free of suspended alkali metal to cathode region 208 via streamline 240c. Notably, solid alkali metal particles can be suspended in the catholyte solution as a result of detachment from the cathode (e.g. when the cathode has a smooth surface). The filtered out solid metal can then be collected and removed from the reactor via stream 240b.

Reference is now made to FIG. 3, which schematically illustrates another reactor in accordance with the presently disclosed subject matter. For simplicity, like reference numerals to those used in FIG. 1, shifted by 200 are used to identify components having a similar function in FIG. 3. For example, component 306 in FIG. 3 is an anode having the same function as anode 106 in FIG. 1.

Specifically, FIG. 3 provides a reactor 300 comprising an electrolytic cell 302, that is divided into a first chamber 350a comprising an anode region 304, comprising an anode 306, a barrier 312, in this non-limiting example is a solid cation selective membrane as described and defined hereinabove, partitioning the anode region 304 from a first cathode region 308a; and a second chamber 350b comprising a second cathode region 308b holding cathode 310, the cathode region configured to operate in a non-aqueous environment as described herein.

Electrolytic cell 302 also comprises power source 314, configured for applying a voltage across the electrolytic cell 302, so as to cause the transfer and precipitation of alkali metal on cathode 310.

Electrolytic cell 302 also comprises in anode region 304 gas outlet 324 for discharging oxygen to the atmosphere.

Cathode region 308b comprises alkali metal outlet 322 configured for removing alkali metal from cathode region 308b and further comprises recirculation streamlines 340a and 340b, such that non-aqueous catholyte is circulated between cathode region 308a and cathode region 308b, by the aid of pump 344.

In addition to electrolytic cell 302, reactor 300 comprises streamline 318, connected connecting a source of alkali metal hydroxide 320 to an evaporating unit 330. Evaporating unit 330 received aqueous based liquid (referred to at times as XOH waste) from a source of alkali metal hydroxide 320 and from anode region 304, via streamline 328 and is configured to evaporate water via outlet 332. The feed line from source 320 and anolyte from anode region 304 are preferably mixed prior to being introduced into evaporating unit 330. By evaporating water, alkali metal hydroxide enriched liquid is obtained in evaporating unit 330 which in turn is fed through streamline 334 and feed inlet 316, into anode region 304, optionally by the aid of a pump such as pump 342.

In some examples, at least part of the anolyte solution exiting the anode region via outlet 326 can bypass the evaporating unit 330 and can be recirculated into anode region 304, via streamline 328a by the aid pump 342. The extent of this bypass stream is dictated by the type and efficiency of the evaporator and by the concentration of raw XOH waste presented in stream 318.

In operation, XOH waste communicated as streamline 318 is firstly mixed with lean XOH, exiting anode region from anode outlet 326 and the mixture is fed into evaporating unit 330, where it is treated to obtain a XOH rich liquid. The XOH rich liquid is circulated into anode region via streamline 334 and feed inlet 316, optionally by the aid of a pump such as pump 342. Alkali metal cation is transferred from the anode region 304 into the cathode region 308, via the alkali metal cation selective membrane, where the alkali metal is produced and communicated out of the electrolytic cell 302 via outlet 322.

Reference is now made to FIG. 4, which schematically illustrates a reactor in accordance with some other examples of the presently disclosed subject matter. For simplicity, like reference numerals to those used in FIG. 1, shifted by 300 are used to identify components having a similar function in FIG. 4. For example, component 406 in FIG. 4 is an anode having the same function as anode 106 in FIG. 1.

Specifically, FIG. 4 provides a reactor 400 comprising an electrolytic cell 402, including an anode chamber 450, a first cathode chamber 452a and a second cathode chamber 452b.

Anode chamber 450 is divided by an alkali metal cation selective barrier 412 into an anode region 404, comprising an anode 406, and a first cathode region 408 within the anode chamber 450. Anode region 404 holds an anode 406 while first cathode region in anode chamber 450 is lacking the presence of a cathode.

Electrolytic cell 402 also comprises power source 414, configured for applying a voltage across the electrolytic cell 402, so as to cause the transfer and precipitation of alkali metal on cathode 410a and 410b.

Anode chamber 450 comprises gas outlet 424 configured for discharging oxygen from anode region 404.

In addition to electrolytic cell 402, reactor 400 also comprises streamline 418, connecting a source of alkali metal hydroxide 420 to an evaporating unit 430. Evaporating unit 430 received aqueous based liquid (referred to at times as XOH waste) from a source of alkali metal hydroxide 420 and from anode region 404, via streamline 428 and is configured to evaporate water via outlet 432. The feed line from source 420 and anolyte from anode region 404 are preferably mixed prior to being introduced into evaporating unit 430. By evaporating water, alkali metal hydroxide enriched liquid is obtained in evaporating unit 430 which in turn is fed through streamline 434 and feed inlet 416, into anode region 404, optionally by the aid of a pump such as pump 442.

In some examples, at least part of the anolyte solution exiting the anode region via outlet 426 can bypass the evaporating unit 430 and can be recirculated into anode region 404, via streamline 428a and the aid of pump 442. The extent of this bypass stream is dictated by the type and efficiency of the evaporator and by the concentration of raw XOH waste presented in stream 418.

In reactor 400, first cathode region 408 in anode chamber 450 has a first cathode region outlet 446 configured for communicating non-aqueous catholyte liquid into a first cathode chamber 452a or to a second cathode chamber 452b, via a controlled opening and closing of valves V_A1, V_A2, V_B1 and V_B2.

First cathode chamber 452a defines a second cathode region 408a and holds a first cathode 410a and having a second cathode region outlet 446a, while second cathode chamber 452b defines a third cathode region 408b, and holds a second cathode 410b and has a third cathode region outlet 446b.

In operation, catholyte liquid is introduced into first cathode chamber 452a or into second cathode chamber 452b via the controlled operation of valves V_A1, V_A2, V_B1 and V_B2. For example, when first cathode chamber 452a is filled with solid alkali metal (which needs to be removed) or otherwise needs to cease activity, it is disconnected from the source of catholyte liquid exiting outlet 446a by turning valves V_A1 and V_A2 into a closed position while turning valves V_B1 and V_B2 to open position for second cathode chamber 452b, and vice versa, when second cathode chamber 452b is filled with solid alkali metal or otherwise needs to cease activity, it is disconnected from the source of catholyte liquid exiting outlet 446b while the streamline to first cathode chamber 452a opens. Upon disconnection of a cathode chamber, the solid alkali metal can be removed and/or the chamber can be subjected to any other necessary treatments. Such operation allows the continuous operation of the reactor 400 and smooth metal Na removal.

Catholyte liquid is circulated between second cathode region 408a or/and 408b to first cathode region 408 via streamline 440, by the aid of pump 444. Pump 444 suction line is either from cathode chamber 452a or 452b and is dictated by position of valves V_A2 and V_B2 as explained previously. In some cases, cathode chambers 452a and 452b can operate simultaneously.

Each of first cathode chamber 452a and 452b have respective alkali metal outlets 422a and 422b.

Reference is now made to FIG. 5, which schematically illustrates another reactor in accordance with the presently disclosed subject matter. For simplicity, like reference numerals to those used in FIG. 1, shifted by 400 are used to identify components having a similar function in FIG. 5. For example, component 506 in FIG. 5 is an anode having the same function as anode 106 in FIG. 1.

Specifically, FIG. 5 provides a reactor 500 comprising an electrolytic cell 502, that includes a chamber 560 a top end 562 and a bottom end 564. Bottom end 564 holds a layer of gel polymer electrolyte (GPE) 566. FIG. 5 also shows an optional addition of an alkali cation selective barrier 512 sandwiched between GPE layer 566 and the anode region 504.

Chamber 560 comprises a partitioning wall 568 that extends from top end 562 towards bottom end 564 and is partially embedded in GPE 566, thus leaving free passage of alkali metal cations to pass from anode region 504 located at one side of partitioning wall 568 to the cathode region 508 on the opposite side of partitioning wall 568. GPE 566 has the meaning as described and defined hereinabove.

Anode region 504 holds anode 506 while cathode region 508 holds cathode 510. Anode region also includes a gas outlet 524 for discharging to the atmosphere oxygen gas produced thereon.

Cathode region 508 is configured to circulate non-aqueous catholyte therewithin via circulating streamline 540, operated by the aid of pump 544. Cathode region 508 also comprises alkali metal outlet 522 configured for removing alkali metal from the cathode region 508.

Electrolytic cell 502 also comprises power source 514, configured for applying a voltage across the electrolytic cell 502, so as to cause the transfer and precipitation of alkali metal on cathode 510.

In addition to electrolytic cell 502, reactor 500 also comprises streamline 518, connecting a source of alkali metal hydroxide 520 to an evaporating unit 530. Evaporating unit 530 received aqueous based liquid (XOH waste) from a source of alkali metal hydroxide 520 and from anode region 504, via streamline 528 and is configured to evaporate water via outlet 532. Feed line 518 from source 520 and anolyte from anode region 504 are preferably mixed prior to being introduced into evaporating unit 530.

By evaporating water, alkali metal hydroxide enriched liquid is obtained in evaporating unit 530 which in turn is fed through streamline 534 and feed inlet 516, into anode region 504, optionally by the aid of a pump such as pump 542.

In some examples, at least part of the anolyte solution exiting the anode region via outlet 526 can bypass evaporating unit 530 and be recirculated into anode region and via streamline 528a, by the aid pump 542. The extent of this bypass stream is dictated by the type and efficiency of the evaporator and by the concentration of raw XOH waste presented in stream 518.

Finally, reference is now made to FIG. 6, which schematically illustrates another reactor in accordance with the presently disclosed subject matter. For simplicity, like reference numerals to those used in FIG. 1, shifted by 500 are used to identify components having a similar function in FIG. 6. For example, component 606 in FIG. 6 is an anode having the same function as anode 106 in FIG. 1.

Specifically, FIG. 6 provides a reactor 600 comprising an electrolytic cell 602, that includes a chamber 660 divided into an anode region 604 including an anode 606 and configured to hold an aqueous anolyte and a cathode region 608 comprising gel polymer electrolyte (GPE) 666. As illustrated, GPE 666 occupies the entire cathode region 608 and the interface between anolyte present in anode region and GPE 666 define a boundary 670 between the two regions. Further illustrated in FIG. 6, is the optional addition of an alkali metal cation selective barrier 612 interfacing the anode region 604 and the GPE 666.

Cathode 610 is embedded in GPE 666 and alkali metal precipitated on cathode 610 illustrated as layer 672. Precipitated alkali metal 672 can be removed from outlet 622.

FIG. 6 also illustrates power source 614, configured for applying a voltage across the electrolytic cell 602, so as to cause the transfer and precipitation of alkali metal on cathode 610; and evaporating unit 630 with its water outlet 632, and streamlines 628 and 634, configured to operate as described in any of the above FIGS. 1 to 5.

The method and reactor disclosed herein can form part of a chemical plant that requires regeneration of alkali metal from by-products of the process and/or from product waste, referred to herein as “XOH waste” (X representing the alkali metal cation).

The XOH waste can be obtained from different sources.

In some examples of the presently disclosed subject matter, XOH is NaOH waste which can be obtained from NaBH₄ or KBH₄ production process. The spent fuel can be treated in a spent fuel treatment unit that is configured to receive the spent fuel and to produce from the spent fuel the KBH₄ or NaBH₄ and the waste stream composed of NaOH. The NaOH can then be used to obtain solid Na which can be further reused in KBH₄/NaBH₄ production process as a source for NaH according to the following balanced chemical equation (1):

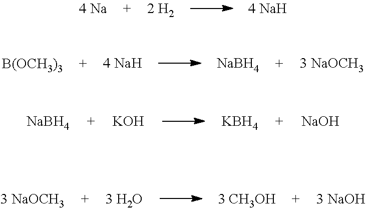

### Overall Equation:

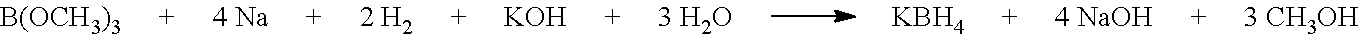

The KBH₄ is then purified and the removed NaOH can be processed into metal Na in accordance with the presently disclosed subject matter.

As used herein, the forms “a”, “an” and “the” include singular as well as plural references unless the context clearly dictates otherwise. For example, the term “a cathode” includes one or more cathodes within the cathode region.

Further, as used herein, the term “comprising” is intended to mean that the composition include the recited components, e.g. a reactor comprising an electrolytic cell, but not excluding other elements, such as control units that can form part of the reactor.

Further, all numerical values, e.g. when referring amounts or ranges of the elements constituting aspects of the presently disclosed subject matter, are approximations which are varied (+) or (−) by up to 20%, at times by up to 10% of from the stated values. It is to be understood, even if not always explicitly stated that all numerical designations are preceded by the term “about”.

The presently disclosed subject matter will now be exemplified in the following description of experiments that were carried out in accordance with the invention. It is to be understood that these examples are intended to be in the nature of illustration rather than of limitation. Obviously, many modifications and variations of these examples are possible in light of the above teaching. It is therefore, to be understood that within the scope of the appended claims, the invention may be practiced otherwise, in a myriad of possible ways, than as specifically described hereinbelow.

### SOME NON-LIMITING EXAMPLES

### Example 1—Catholyte Solvent Screening

### Materials & Method

Screening of optional solvents was performed by long term exposure to sodium metal at conditions summarized below. The tested solvents included Glyme (ethylene glycol dimethyl ether), Diglyme (diethylene glycol dimethyl ether), NMP (N-Methyl-2-pyrrolidone), Dibutyl glyme (diethylene glycol dibutyl ether) & THF (Tetrahydrofuran).

To this end, 3-neck flask was dried with high temperature fan and then was inerted by vacuum/Ar washing (by Schlenk system). About 50 ml of the tested solvent was added. The solvent was previously dried using molecular sieves.

Flattened piece of Na (~0.7 g) with specific Na area of about 50 m Na/m³ solution Was added to the tested solvent.

Gentle solution mixing was achieved by Ar bubbling.

### Results

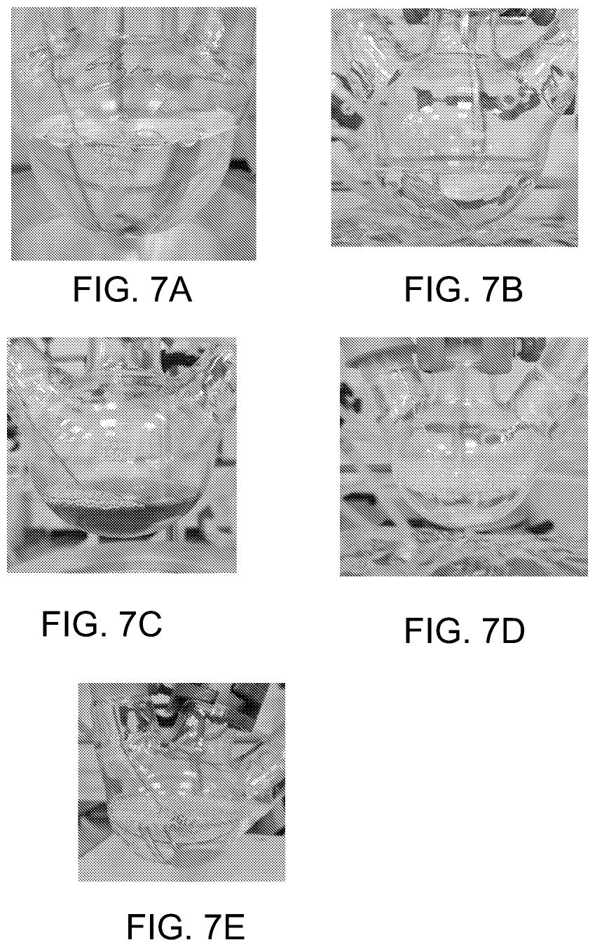

The solvents were exposed to metal sodium overnight. FIGS. 7A to 7E are images of the flasks after overnight exposure of the Na pieces to Glyme (FIG. 7A), Diglyme (FIG. 7B), NMP (FIG. 7C), Dibutyl Glym (FIG. 7D) and THF (FIG. 7E).

As shown in FIG. 7A to 7E, Glyme, Diglyme, Dibutyl glyme and THF remained clear with no change of liquid color. The liquid in the NMP containing flask turned deep red and it was thus concluded to be reactive with sodium metal and therefore not suitable.

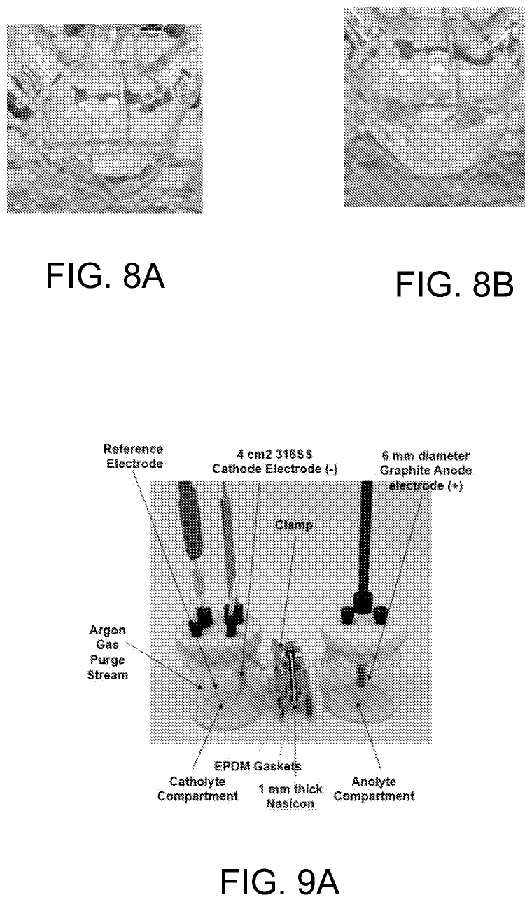

Diglyme was further exposed for a week to test the long-term exposure effects. FIGS. 8A-8B are images of the Diglyme containing flask after overnight exposure (FIG. 8A) and after a week exposure (FIG. 8B).

As shown in FIG. 8B, Diglyme solvent remained clear with no color change even after a week exposure. Further, the Na surface remained visually unchanged.

### Example 2—Electrolysis H-Cell Experiments

### Example 2A—Na Production Using Nasicon Na⁺ Selective Membrane

### Materials & Method

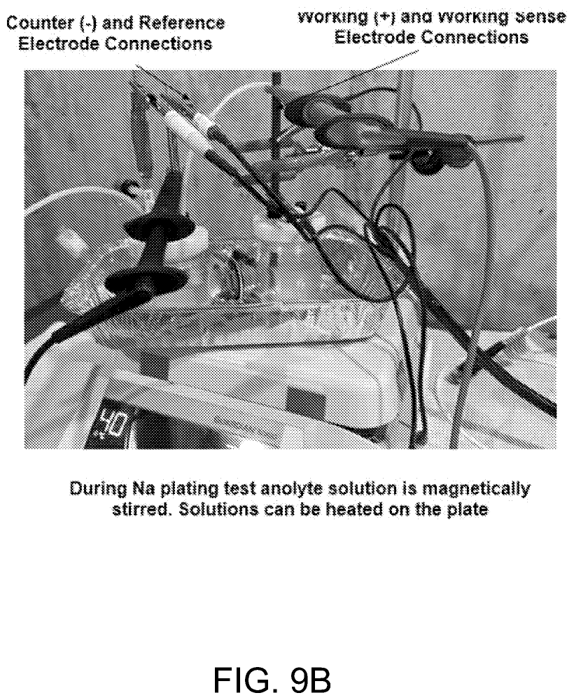

Metal Na production experiments were conducted in laboratory H-Cell system using NMP or Diglyme as the selected solvents (based on the results of Example 1). The system setup is provided in FIGS. 9A-9B.

Specifically, FIG. 9A shows a typical H-Cell setup containing a catholyte compartment including a cathode electrode, a reference electrode, argon gas purge inlet and outlet (tubes for providing stream of argon and directing the exhaust Argon outside the catholyte compartment), an anolyte compartment including an anode electrode, and an EPDM rubber gasket held by a clamp and holding 1 mm thick NaSICON Na⁺ selective membrane. Notably, the reference electrode is used to precisely measure the potential drop on the cathode.

FIG. 9B shows the actual H-Cell setup used in the current non-limiting examples with the connection of the H-Cell system to the power source and stirring/heating plate.

Specifically, the tested setup used the following:
Anolyte: 45% NaOH in DI Water, 70 g
Separator: NaSICON disk, 1 mm thick
Electrodes: 6 mm diameter graphite (anode), 2 cm×2 cm 316SS (cathode), Ag/Ag+ (reference electrode)
Test Conditions: Temperature=18° C., magnetically stirred anolyte, 150 sccm Argon flow rate bubbled through catholyte compartment.

### Results

In all experiments bubbling was observed on anode surface. O₂ generated on the anode compartment from water oxidation (desired reaction); while no gas bubbling observed on the surface of the cathode, confirming that the only gas generated is O₂ and there is no destruction of the cathode and no water in the catholyte.

After about 15-30 minutes, Na metal plating on the cathode was visually observed and was verified by water test after the end of experiment. Notably, the Na is observed as a grey shiny coating growing on the cathode. The formation of solid Na can also be determined using a water test. A “water test” includes immersing the cathode in water at the end of the experiment and observing the rapid generation of bubbles and pH increase of the solution which is a result of reaction of Na with water to generate Hydrogen and NaOH).

Catholyte of NMP/NaClO₄ turned yellow due to reaction of NMP with sodium metal (as expected from Example 1—in the long-term sodium exposure).

Catholyte of Diglyme/NaClO₄ was found to be stable with no discoloring.

While using smooth surface of SS316 cathode some Na remained attached to electrode but most detached and floated in catholyte. Yet, when the SS316 was conditioned using Ni foam or by roughening the SS316 as a cathode, the plated Na remained attached to the conditioned cathode.

Membrane breach simulation was done by addition of NaOH 45% solution (anolyte) to the catholyte (8 g NaOH 45% wt solution to 46 g catholyte) while the cathode was already plated with Na metal. No visible reaction occurred upon the mixing as long as the power was off. Once the power was turned on, bubbling was observed at the cathode electrode surface indicating water reduction to H₂ reaction (water coming from NaOH 45% wt solution).

The above process features dramatically lower energy consumption than the conventional process for metal Na production (Down's process). The conventional metal Na process has high open cell potential of 4.07 V and occurs at a very high temperature of ~600-800° C., extremely high current density of ~10,000 A/m² and rather low current efficiency of ~80%. The above constraints lead to extremely high specific energy consumption of typically >12 kWh/kgNa.

The exemplified process showed lower open cell potential of 3.11 V, occurred at room temperature, current density of 50-100 mA/cm², and had extremely high current efficiency of more than 99% as compared to that from other experiments conducted by the inventor with NaSICON and β-Alumina membranes (not illustrated).

Table 1 above (transcribed hereinbelow) compares parameters of the exemplified production of solid sodium, and parameters of Down's process [USA Report: “Final Report on a Survey of Electrochemical Metal Winning Processes” Battelles Memorial Institute, Department of Energy, [Office of Energy Research], Argonne National Laboratory, 1979, page 210].

TABLE 1
Process Operating Parameters

| | | Current |
|---|---|---|
| Parameter | Down's Process | Method |
| Temperature | >300° C., preferably 600° | <50° C. |
| | C.-800° C. | |
| Metal Na | Hot molten Na | Cold solid Na |
| Corrosive gases | Cl₂ | No |
| OCP* (V) | 4.07 | 3.11 |
| Over Voltage | 3 | 0.9 |
| Current Efficiency | <80% | >99% |
| Total EC | typically >12.0 KWh/Kg_{Na} | <5 KWh/Kg_{Na} |
| Current Density | 10,000 A/m² | 500-1,000 |
| | | A/m² |

### Example 2B—Na Production Using Gel Polymer Electrolyte (GPE)

### Materials & Method

Metal Na production using Gel Polymer Electrolyte is conducted in laboratory H-Cell system similar to that described with respect to Example 2A, yet with a Na⁺ selective barrier that comprises GPE with or without addition of alkali metal selective membrane.

The GPE comprises the following components:
Polymer-Poly-vinylidene fluoride-hexafluoropropylene (PVDF-HFP)
Plasticizer-Liquid electrolyte of 1 M LiPF6 in EC/PC or EC/dimethyl carbonate (DMC) solution.

When used, the organic solvent with alkali metal-based salt comprises Diglyme with 1M NaClO₄ respectively.

Table 2 summarizes variations in H-Cell setup for different set ups as schematically illustrated in FIGS. 5 and 6:

TABLE 2
H- Cell setup using GPE

| Case | Scheme | H-Cell setup |
|---|---|---|
| GPE is the only barrier. | FIG. 5 | Anode region of H-Cell contains an aqueous |
| Cathode is submerged in | without | solution of concentrated NaOH. The cathode |
| organic solution with | barrier 512 | region is filled with GPE. Cathode region |
| alkali metal-based salt | | contains an inner cylindrical vessel filled |
| | | with organic solvent with Na-based salt. The |
| | | inner vessel has walls made of nylon mesh |
| | | to prevent GPE passage but to allow ions |
| | | transfer. The cathode is inserted inside the |
| | | inner vessel. |
| | | The cathode and anode regions are separated |
| | | by porous nylon mesh to support GPE. |
| GPE based barrier is | FIG. 5 with | Anode region of H-Cell contains an aqueous |
| supported by alkali metal | Barrier 512 | solution of concentrated NaOH. Cathode |
| selective barrier. Cathode | | Region is filled with GPE. Cathode region |
| is submerged in organic | | contains an inner cylindrical vessel filled |
| solution with alkali metal- | | with organic solvent with Na-based salt. The |
| based salt | | inner vessel has walls made of nylon mesh |
| | | to prevent GPE passage but to allow ion |
| | | transfer. The cathode is inserted inside the |
| | | inner vessel. |
| | | Cathode and anode regions are separated |
| | | alkali metal selective barrier. |
| GPE is the only barrier. | FIG. 6 | Anode region of H-Cell contains an aqueous |
| Cathode is submerged | without | solution of concentrated NaOH. Cathode |
| directly in GPE | barrier 612 | region is filled with GPE. The cathode is |
| | | directly submerged into GPE. |
| | | Cathode and anode regions are separated by |
| | | porous nylon mesh to support GPE. |
| GPE based barrier is | FIG. 6 with | Anode region of H-Cell contains an aqueous |
| supported by alkali metal | barrier 612 | solution of concentrated NaOH. Cathode |
| selective barrier. Cathode | | region is filled with GPE. The cathode is |
| is submerged directly in | | directly submerged into GPE. |
| GPE | | Cathode and anode regions are separated |
| | | alkali metal selective barrier. |

The applied voltage in all cases is in the range of 4-5 V.

Metal Na production can be observed visually in all cases and can be confirmed by water test at the end of each experiment.

The bubbles formation on the anode surface should be observed in all experiments.

The GPE integrity can be observed visually and by IR, NMR and HPLC tests.

### Example 3—Solid Na Removal

Metal Na is removed from the cathode region either periodically or continuously.

### Periodical Removal

In case of rough or foam type cathodes, the metal Na remains on the cathode surface as a coating layer. The separation of metal Na layer from the cathode can be achieved by putting the coated cathode in hot oil bath. Metal Na melts at a temperature of 97° C. and can be collected as a liquid from the bottom of hot oil bath.

### Continuous Removal

In case of using smooth SS316 plate cathode the metal Na particles formed on the cathode are detached and float in circulated catholyte stream. In such a case, a dedicated settling compartment (identified above in FIG. 2 as alkali metal filtration/settling unit 260) that is designed in a catholyte recycling tank (also referred to as filtering/settling tank/unit) to safely separate solid metal Na particles from circulating stream.

1. A method of producing alkali metal from a feed liquid containing alkali metal hydroxide, the method comprising:
feeding said feed liquid into an electrolytic cell comprising an anode region holding an anode and anolyte, a cathode region holding a cathode and catholyte comprising an alkali metal-based conductive salt in an organic solvent, and a barrier partitioning said anode region and said cathode, said barrier being selective for alkali metal cation transfer from said feed liquid, said anolyte and alkali metal based conductive salt in said catholyte share the same alkali metal cation; and
applying a voltage across the electrolytic cell to cause transfer of said alkali metal cation to said cathode region and precipitation of said alkali metal on said cathode.

2. The method of claim 1, wherein said alkali metal hydroxide comprises an alkali metal selected from the group consisting of sodium, potassium, and lithium.

3-4. (canceled)

5. The method of claim 1, wherein said electrolyte organic solvent is water-free.

6. The method of claim 5, wherein said catholyte is a non-aqueous catholyte, and wherein said electrolyte organic solvent of said non-aqueous catholyte is selected from the group consisting of 1,3-Dioxolan-2-one (EC), dimethyl carbonate (DMC), diethyl carbonate (DEC), 4-methyl-1,3-dioxolan-2-one (PC), dimethyl carbonate (DMC), methylethyl carbonate (MEC) fluoroethylene carbonate (FEC), Oxolane (THF), N,N-Dimethylacetamid (DMAC), N,N-dimethylformamide (DMF), 1-Methylpyrrolidin-2-one (NMP), thiolane 1,1-dioxide (Sulfolane), 1,2-Dimethoxyethane (DME), 1-Methoxy-2-(2-methoxyethoxy) ethane (Diglyme), 2,5,8,11-Tetraoxadodecane (Triglyme), 2,5,8,11,14-Pentaoxapentadecane (Tetraglyme), 1-propoxypropane (DPE), Diethylene glycol dibenzoate (DEGD), Poly(ethylene glycol) (PEG), PEG-dimethyl ether (PEGDEM), Poly(propylene glycol) (PPG), and Tris(2-ethylhexyl)phosphate (TEHP), 1,1,3,3-Tetramethylurea (TMU), 1,1,3,3-Tetraethylurea (TEU), and 1,3-Dimethyl-1,3-diazinan-2-one (DMPU).

7. (canceled)

8. The method of claim 1, wherein said alkali metal-based conductive salt comprises an anion selected from the group consisting of perchlorate (ClO₄⁻), hexafluorophosphate (PF₆⁻), tetrafluoroborate (BF₄⁻), bis(trifluoromethanesulfonyl)imide (N(CF₃SO₂)₂⁻, TFSI), triflate (NaCF₃SO₃⁻, Tf), bis(fluorosulfonyl)imide (N(FSO₂)₂⁻, FSI), I, bis(oxalate)borate (BOB), bis(salicylato)borate (BSB), and tetraphenylborate (BPh₄⁻).

9.-11. (canceled)

12. The method of claim 1, wherein said barrier is a cation selective membrane selected from the group consisting of sodium superionic conductor (NaSICON), LiSICON, KSICON, β-Alumina and fluoropolymer-based ion-exchange membrane containing sulfonic acid groups (Nafion membrane).

13.-20. (canceled)

21. The method of claim 1, comprising concentrating hydroxide level in the feed liquid to be above a predetermined threshold, said concentration being suitable to prevent reaction between said alkali metal and water, if said alkali metal and said water come into contact and optionally controlling concentration of sodium hydroxide in said feed liquid to be at least 35% w/v.

22.-23. (canceled)

24. The method of claim 1, wherein said feed liquid is an aqueous liquid and said method comprises pre-treating said feed liquid to increase hydroxide concentration to a predetermined threshold, said concentration is suitable to prevent reaction between said alkali metal and water, if said alkali metal and said water come into contact.

25. The method of claim 1, comprising recirculating at least part of said anolyte into said anolyte region.

26. (canceled)

27. The method of claim 1, comprising removing alkali metal from said cathode region, wherein said removing of alkali metal from said cathode region comprises treating catholyte from said cathode region in a catholyte recycling tank to separate catholyte from solid alkali metal and returning treated catholyte into said cathode region and/or periodically collecting precipitated alkali metal from said cathode region.

28.-31. (canceled)

32. The method of claim 1, wherein said electrolytic cell comprises two or more separately operated cathode chambers, the two or more cathode chambers housing, respectively, two or more cathode regions, each cathode region containing a cathode and at least one valve for separately opening and closing flow of catholyte into each of said two or more cathode chambers, said method further comprises introducing catholyte into at least one of said two or more chambers while optionally ceasing operation of at least one other of said two or more cathode chambers.

33.-34. (canceled)

35. The method of claim 1, comprising wherein a working temperature in said electrolytic cell of less than 300° C.

36. (canceled)

37. A reactor for use with a source of alkali metal hydroxide in an aqueous media, the reactor comprising:
an electrolytic cell comprising an anode region comprising an anode, a cathode region comprising a cathode and configured for operating within an electrolyte organic solvent and a barrier partitioning the anode region from the cathode, the barrier being selective for alkali metal cation conduction;
a power source configured for applying a voltage across the electrolytic cell;
a feed inlet in liquid communication with said source of alkali metal hydroxide;
an alkali metal outlet configured for discharging alkali metal from said cathode region; and
at least one gas outlet configured for discharge of gas from said anode region to the atmosphere.

38. The reactor of claim 37, wherein said anode region comprises a liquid outlet in liquid communication with an evaporating unit, the evaporating unit configured for evaporating water from anolyte being communicating from the anode region to obtain alkali metal hydroxide enriched anolyte, the evaporating unit further being configured to communicate said alkali metal hydroxide enriched anolyte into said anode region.

39. (canceled)

40. The reactor of claim 38, comprising a communication line for directly communicating alkali metal hydroxide waste from said source of alkali metal hydroxide into said evaporating unit.

41. (canceled)

42. The reactor of claim 37, wherein said barrier is a cation selective membrane consisting of sodium superionic conductor (NaSICON), KSICON, LiSICON, β-Alumina and fluoropolymer-based ion-exchange membrane containing sulfonic acid groups (Nafion membrane).

43.-49. (canceled)

50. The reactor of claim 40, comprising a first chamber comprising said anode region and a first cathode region, the anode region and the first cathode region being partitioned by said barrier; and at least one additional cathode chamber comprising a respective cathode region in fluid communication with said first cathode chamber.

51. The reactor of claim 50, comprising two or more additional cathode chambers, and at least one valve switchable between an open and closed position and configured for controlled introduction of catholyte into each of said two or more additional catholyte chambers.

52.-54. (canceled)

55. The reactor of claim 37, comprising a water removal unit configured to reduce water content in anolyte received from said anode region and communicate anolyte from said water removal unit, having a concentration above a predefined threshold back into said anode region.

56. (canceled)

57. A plant comprising a spent fuel treatment unit and a reactor according to claim 37;
wherein the spent fuel treatment unit is configured to (1) receive said spent fuel and (2) produce from said spent fuel XBH₄, wherein said X represents an alkali metal cation; and
wherein said spent fuel treatment is configured to receive from said reactor precipitated Na, wherein Na can be different from said X, and to discharge a stream of NaOH waste into said reactor.
